(19) United States
(12) Patent Application Publication
(10) Pub. No.: US 2023/0050516 A1
(43) Pub. Date: Feb. 16, 2023

(54) Method of Polishing to Enhance the Reflective Potential of Automotive Sun Shades Coated with Reflective Metallic Paint

(71) Applicant: Volker Schafer, Perth (AU)

(72) Inventor: Volker Schafer, Perth (AU)

(21) Appl. No.: 17/399,084

(22) Filed: Aug. 11, 2021

(51) Int. Cl. B05D 5/06; B24B 29/02; B05D 1/12; B05D 3/12; B05D 7/02; B05D 7/24

(52) U.S. Cl. CPC B05D 5/063; B24B 29/02; B05D 1/12; B05D 3/12; B05D 7/02; B05D 7/24

(57) ABSTRACT

The quality of an automotive sun shade is frequently determined by the reflective paint used in the manufacturing of the sun shade. This invention discloses a method of polishing reflective metallic paint after its application onto the material of automotive sun shades leading to an improvement in the reflective potential of the surface of the paint. The outcome is a measureable improvement in product performance.

### TECHNICAL FIELD

This invention relates to the automotive industry, and particularly to the methods involved in coating automotive sun shades with reflective metallic paint during the manufacturing process. The reflective quality of the metallic paint is enhanced via intense polishing of the paint after its application onto the surface of the material of the windshield sun shade.

### BACKGROUND OF THE INVENTION

In the many years of the automotive industry, automotive sun shades have developed into commonly used automotive accessories. Past patented inventions date as early as 1911. Typically, the glass of a vehicle's windshield or window blocks a significant proportion of the UV light from the sun, and some of the infrared radiation. But it does not protect from the majority of visible light that penetrates through the glass and is absorbed by objects inside the vehicle. The visible light that passes into the interior of a vehicle is converted into infrared light which, in turn, becomes trapped inside the vehicle, heating up the interior. Some automotive sun shades, particularly windshield sun shades, have a reflective surface that serve to reflect sun light away from the vehicle, thereby reducing the amount of light radiation entering the vehicle, causing the interior of the vehicle to heat at a reduced rate when compared with non-reflective sun shades.

Automotive sun shades are most commonly used in regions subject to warm and sunny weather, and the frequency of their use is typically higher during the hotter summer months. During the summer automotive sun shades can help reduce the internal temperature of parked vehicles and protect occupants and objects inside a vehicle from solar radiation. Sunlight passing through a vehicle's windows produce a greenhouse effect, heating the interior to a temperature substantially higher than that of the air outside. In extreme conditions, without any protection, trapped solar radiation can elevate temperatures to above 65 degrees Celsius within 60 minutes. Such high temperatures are a potential health hazard for people or animals entering a vehicle. Furthermore, prolonged exposure to direct sunlight can cause damage to objects inside a vehicle such as dashboards, seats and electronic devices.

There are several variants of reflective automotive sun shades, and in most cases they are designed for the windshield of a vehicle. Traditionally, windshield sun shades are made of a layer of aluminum foil covering cardboard or flexible synthetic material that is placed inside a vehicle against the windshield. More recently foldable windshield sun shades have become popular due to their flexible light weight design and ability to fold away for easy storage. These types of sun shades usually consist of a thin layer of fabric supported by thin flexible metal frames. They are designed to block and reflect solar radiation and are similarly installed in the interior of a vehicle against the windshield. The reflective coating of these types of sun shades is in almost every case a type of metallic paint. The metallic components within the paint are typically reflective in nature and in most cases are particles of ultra-fine aluminum flakes. It is these metallic components that give the coating its valuable reflective potential. In addition to windshield sun shades, various other types of automotive sun shades have been created with metallic paint coatings that are designed to be placed upon or against the side and rear windows of vehicles.

Few patents have been filed with regard to this subject matter, particularly in relation to methods of polishing a painted reflective surface to enhance reflective quality. The current invention relies on the intensive polishing of a reflective paint, or thin paint-like coating, applied to material such as microfiber fabric, and in the way it improves the reflective quality of sun shades.

In some aspects, this application may claim benefit, directly or indirectly from several patent applications and prior art literature including:

U.S. Pat. No. 8,446,666B2: The present invention discloses a non-quarter wave multilayer structure having a plurality of alternating low index of refraction material stacks and high index of refraction material stacks. The plurality of alternating stacks can reflect electromagnetic radiation in the ultraviolet region and a narrow band of electromagnetic radiation in the visible region. The non-quarter wave multilayer structure, i.e. nLdL≠nHdH≠λ0/4, can be expressed as [A 0.5 qH pL(qH pL)N 0.5 qH G], where q and p are multipliers to the quarter-wave thicknesses of high and low refractive index material, respectively, H is the quarter-wave thickness of the high refracting index material; L is the quarter-wave thickness of the low refracting index material; N represents the total number of layers between bounding half layers of high index of refraction material (0.5 qH); G represents a substrate and A represents air.

U.S. Pat. No. 8,361,217B2: Metal paint containing water and/or an organic solvent, as well as at least one film-forming agent, at least one organo-functional silane and at least one metallic effect pigment characterized in that the metallic effect pigment is a floating pigment with aluminum effect

U.S. Pat. No. 9,056,988B2: Disclosed are infrared reflective coating compositions and cured coatings deposited on a substrate, as well as multi-component composite coating systems. The coating compositions include an infrared transparent pigment and an infrared reflective pigment.

U.S. Ser. No. 10/214,449B2: Dark colored roofing granules include an inert base particle coated with a composition including a metal silicate, a non-clay latent heat reactant, and a dark colored but solar reflective pigment.

U.S. Pat. No. 9,558,679B2: An organic release agent is vacuum deposited over a substrate and surface treated with a plasma or ion-beam source in a gas rich in oxygen-based functional groups to harden a very thin layer of the surface of the deposited layer in passivating environment. Aluminum is subsequently vacuum deposited onto the hardened release layer to form a very flat and specular thin film. The film is exposed to a plasma gas containing oxygen or nitrogen to passivate its surface. The resulting product is separated from the substrate, crushed to break up the film into aluminum flakes, and mixed in a solvent to separate the still extractable release layer from the aluminum flakes. The surface treatment of the release layer greatly reduces wrinkles in the flakes, improving the optical characteristics of the flakes. The passivation of the flake material virtually eliminates subsequent corrosion from exposure to moisture.

U.S. Pat. No. 9,012,938B2: Apparatuses and methods for producing light emitting devices maximizing luminous flux output are disclosed. In one possible embodiment, a light emitting device comprises a substrate and a reflective layer at least partially covering the substrate. The reflective layer is non-yellowing, and may be substantially light transparent. One or more light emitting diode (LED) chips are disposed on the substrate. The light emitting device may emit white light. The reflective layer may comprise a silicone carrier with light reflective particles dispersed in the silicone carrier. Alight diffusion lens may also be disposed on the substrate and surrounding the LED chips. Furthermore, one or more microspheres, light scattering particles, and/or phosphor particles may be dispersed in the lens. In one possible method for producing a light emitting device, a substrate is provided. One or more LED chips are coupled with the substrate, and a high reflective, non-yellowing coating is applied on at least a portion of the top surface of the substrate. The coating comprises a carrier with reflective particles dispersed throughout.

U.S. Ser. No. 10/392,806B2: A solar heat-reflective roofing product includes a base sheet, and solar heat-reflective roofing granules on top of the base sheet. The granules have a base particle with a flake-like geometry covered by a uniform coating layer. The coating layer has a thickness of at least one mil and includes a coating binder and at least one solar heat-reflective pigment. The solar heat-reflective pigment provides a solar heat reflectance of greater than 70 percent to the granules and the roofing product. Roofing products including roofing shingles and roofing membranes are described.

In this disclosure is an invention that relates to automotive sun shade technology that can be applied in the manufacturing process of reflective automotive sun shades.

### OBJECTIVES OF THE INVENTION

The principle objective of the invention is to improve the reflective quality of automotive windshield sun shades by introducing a new and unique method of polishing reflective metallic paint after it has been applied to the sun shade surface. The improved reflective potential can be determined via comparative temperature measurements inside identical vehicles parked outside under direct sunlight.

### SUMMARY OF THE INVENTION

The following summary provides a basic explanation of the scope of the invention as well as the steps concerning the materials, method and apparatus of the invention. This summary is not an extensive overview of the invention and does not intend to limit the scope beyond what is described and claimed as a summary.

The said invention discloses a method of improving the reflective quality of reflective metallic paint after application to the surface of the material of automotive sun shades, involving steps of polishing the painted surface. More broadly, the present invention relates to a new way of modifying a surface coated in reflective metallic paint via polishing resulting in improved product quality and effectiveness that offers a competitive edge in the performance of reflective automotive sun shade products.

The paint is first applied via spraying onto the surface of the material of the sun shade (typically microfiber fabric) and then it is allowed to dry until it can be handled without marring. Once the paint is sufficiently dry the new novel approach is to vigorously polish the paint with a fine microfiber type cloth or polisher (by hand or machine). This action removes paint dust that is loosely stuck to the top surface of the paint. It also better aligns the reflective components (ultra-fine metallic particles) along the paint surface. Doing this enhances the reflective capacity of the painted surface and the result, according to preliminary tests, is improved reflectivity of the sun shade material, as measured by temperature differential.

### BRIEF DESCRIPTION OF FIGURES

FIG. 1 illustrates a method of improving the reflective potential of reflective metallic paint via polishing the paint after it has been applied to the surface of sun shade material.

### DETAILED DESCRIPTION OF THE INVENTION

The current invention relates to a new way of modifying a surface coated in reflective metallic paint via intensive polishing post application for improved reflective performance on automotive windshield sun shades.

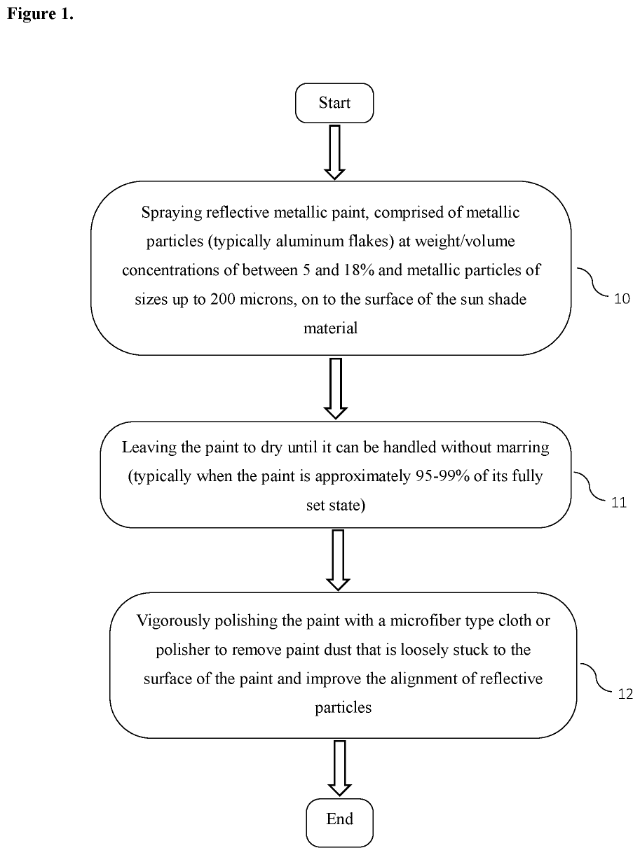

Generally, and as shown in FIG. 1, the said invention describes a method of applying a reflective metallic paint to a surface. It further describes a method of polishing the paint post application, immediately once the paint has dried sufficiently that it can be handled without marring.

More specifically, the invention describes a type of reflective paint that is metallic based and the process of polishing the paint at a defined period and in a defined way after application onto the material of the automotive sun shades.

Reflective metallic paints relevant to this invention contain ultra-fine metallic particles (typically in the form of aluminum flakes) at sizes of up to 200 microns, and at total weight/volume concentrations of between 5 and 18% within the paint (specifications typical of reflective paint used in the manufacture of automotive sun shades). The paint is applied onto the surface of the material of the sun shades and is then allowed to dry until it can be handled without marring.

As summarized in FIG. 1 of the diagrams, the invention demonstrates a novel approach for polishing the paint once it has dried sufficiently that it can be handled without adversely impacting the visual quality of the surface. In the first step (10) the reflective paint is applied via spraying onto the surface of the sun shade material. Thereafter the paint is allowed to dry until it can be handled without marring (i.e. when the paint is approximately 95-99% of its fully set state) (11). At this point (12) the painted surface is vigorously polished, either manually with a soft microfiber type cloth, or with the aid of a mechanical polisher. The polishing is performed in a consistent pattern and direction and with pressure (without marring the painted surface or damaging the material). The polishing action removes visible and microscopic paint dust that is loosely stuck to the top surface of the paint and also flattens and aligns a significant proportion of the reflective metallic flakes positioned at the paint surface. The outcome, according to preliminary tests, is an enhancement of the reflective capacity of the painted surface of the sun shade material, as measured by temperature differential.

The current invention introduces improved sun shades for use in a windshield, side or rear window of an automobile. The invention creates a superior reflective surface capable of reflecting a higher percentage of sun light, thereby improving the functionality of the sun shades. No specific emphasis is made here of the material used to construct the sun shades. The material may be microfiber fabric, alternative fabrics, plastic etc., or a combination of different materials.

### BEST MODE OF CARRYING OUT THE INVENTION

1. In prelude to the invention, a suitable reflective metallic paint is selected, comprising of ultra-fine reflective metallic particles of sizes up to 200 microns, and a total weight/volume concentration of between 5 and 18%. The paint is sprayed uniformly onto the material surface of the automotive sun shades.
2. After application of the paint, the invention describes a process whereby it is necessary to wait until the paint is almost completely dry (until it can be handled without marring), typically at between 95 and 99% of its fully set state. From this point the invention outlines a process of;
   a. vigorously polishing the paint with a soft microfiber type cloth or mechanical polisher in a consistent pattern and direction and with pressure (without marring the painted surface or damaging the material), in order to enhance the reflective capacity of the paint surface via:
      (i) removal of visible and microscopic paint dust that is loosely stuck to the top surface of the paint, and;
      (ii) improved alignment of the ultra-fine reflective metallic flakes positioned at the surface of the paint.

### INDUSTRIAL APPLICATION

The current invention is applicable in the automotive industry, specifically the manufacturing of reflective automotive sun shades. This new method of improving the reflective quality of automotive sun shades has demand in the market.

What is claimed is:

1. A method of improving the reflective quality of reflective metallic paint, defined as paint containing ultra-fine reflective metallic particles of sizes up to 200 microns and a total metallic particle weight/volume concentration of 5 to 18%, by:
a. spraying the paint onto the surface, and waiting until the paint is almost completely dry at between 95 and 99% dry, and;
b. vigorously polishing the paint with a soft microfiber type material in a consistent pattern and direction and with pressure to enhance the reflective capacity of the paint surface via:
(i) removal of paint dust that is loosely stuck to the top surface of the paint, and;
(ii) improved alignment of the ultra-fine reflective metal particles positioned at the surface of the paint.

2. The method of claim 1, wherein the polishing is done manually.

3. The method of claim 1, wherein the polishing is done mechanically.

4. The method of claim 1, wherein the surface comprises fabric.

5. The method of claim 1, wherein the surface comprises plastic.

6. The method of claim 1, wherein the surface is a combination of materials.

7. The method of claim 1, wherein it is applied to the manufacturing process of automotive windshield sun shades.

8. The method of claim 1, wherein it is applied to the manufacturing process of automotive side window sun shades.

9. The method of claim 1, wherein it is applied to the manufacturing process of automotive rear window sun shades.

10. The method of claim 1, wherein it is applied to the manufacturing process of automotive sun protection covers, such as car covers.
